(19) United States
(12) Patent Application Publication
(10) Pub. No.: US 2024/0079863 A1
(43) Pub. Date: Mar. 7, 2024

(54) DRAIN WIRE CORRECTING DEVICE AND DRAIN WIRE CORRECTING METHOD

(71) Applicant: Shinmaywa Industries, Ltd., Takarazuka-shi, Hyogo (JP)

(72) Inventors: Yoshiki TAKAHASHI, Takarazuka-shi (JP); Naoki FUJISAWA, Takarazuka-shi (JP); Ayako SHIMMURA, Takarazuka-shi (JP); Miyuki MATSUMOTO, Takarazuka-shi (JP)

(21) Appl. No.: 18/269,055

(22) PCT Filed: Dec. 15, 2021
(86) PCT No.: PCT/JP2021/046376

§ 371 Date: Jun. 22, 2023

(30) Foreign Application Priority Data
Dec. 24, 2020 (JP) 2020-215191

(51) Int. Cl. H02G 1/14

(52) U.S. Cl. CPC H02G 1/14

(57) ABSTRACT

A drain wire correcting device 10 includes: a retention device 20 configured to retain a sheathed portion 1a of a multi-core cable 1; gripping members 41, 42 configured to grip a drain wire 2 on an axis Ax; a moving device 60 configured to move at least one of the multi-core cable 1 and the gripping members 41, 42 along the axis Ax; and a rotating device 70 configured to rotate at least one of the multi-core cable 1 and the gripping members 41, 42 around the axis Ax. The drain wire correcting device 10 executes a squeeze control of moving the gripping members 41, 42 along the axis Ax while the gripping members 41, 42 are in contact with the drain wire 2, thereby squeezing the drain wire 2 toward a distal end side, and executes, after the squeeze control, a rotation control causing the gripping members 41, 42 to grip the drain wire 2 with a gripping force increased from that in the squeeze control and rotating the gripping members 41, 42 around the axis Ax.

### TECHNICAL FIELD

The present invention relates to a drain wire correcting device and a drain wire correcting method.

### BACKGROUND ART

Multi-core cables have been known in the art, including a drain wire and a plurality of core wires covered by a sheath. When processing a multi-core cable, the drain wire and the plurality of core wires are normally separated and processed separately. For example, PTL 1 discloses a heat-shrink tube installment device having a carrying section for inserting a drain wire into a heat-shrink tube and a heating unit for heating the heat-shrink tube.

Before performing a process such as insertion into a heat-shrink tube, for example, for a drain wire composed of a plurality of strands, it is desirable to rectify the shape of the drain wire straight and then organize the strands so that they do not come apart (hereinafter referred to as correcting the drain wire). If the drain wire is not desirably corrected, post-processing of the drain wire such as insertion into the heat-shrink tube becomes difficult. Therefore, devices for correcting the drain wire have been devised in the art. For example, PTL 2 discloses a device for stretching the drain wire sandwiched between a pair of gripping members (brushes) and, from a middle point, rotating the gripping members around the axis of the drain wire.

### CITATION LIST

### Patent Literature

PTL 1: JPA 2016-123215
PTL 2: JPA S64-81608

### SUMMARY OF INVENTION

### Technical Problem

The present inventors have confirmed that by gripping the drain wire by the gripping member and moving the gripping member toward the distal end side of the drain wire, the strands of the drain wire can be brought together and the drain wire can be shaped straight. By thereafter rotating the gripping member around the axis of the drain wire, it is possible to twist the drain wire. Note however that if the gripping force of the gripping member is strong, the drain wire is pulled too strongly during the movement of the gripping member, and problems such as the strands of the drain wire being cut are likely to occur. On the other hand, if the gripping force of the gripping member is weakened, when twisting the drain wire by rotating the gripping member, the drain wire is likely to slip against the gripping member so that the drain wire is not twisted sufficiently. Thus, even if the drain wire is sandwiched and stretched by the gripping member and the holding member is rotated around the axis of the drain wire from a middle point, the drain wire is not always corrected desirably.

The present invention has been made in view of these points, and an object thereof is to provide a drain wire correcting device that can correct the drain wire desirably. It is also an object to provide a drain wire correcting method with which it is possible to correct the drain wire desirably.

### Solution to Problem

A first drain wire correcting device according to the present invention includes: a retention device configured to retain a sheathed portion of a multi-core cable, the multi-core cable including the sheathed portion covered with a sheath and a drain wire exposed from the sheathed portion; a gripping member configured to be capable of gripping the drain wire on a predetermined axis; a drive device configured to drive the gripping member so as to grip or release the drain wire; a moving device configured to move at least one of the multi-core cable retained by the retention device and the gripping member along the axis; a rotating device configured to rotate at least one of the multi-core cable retained by the retention device and the gripping member around the axis; and a controller configured to control the drive device, the moving device and the rotating device. The controller is configured to execute a squeeze control, and a rotation control after the squeeze control. The squeeze control is a control of moving the gripping member along the axis relative to the multi-core cable while the gripping member is in contact with the drain wire, thereby squeezing the drain wire toward a distal end side. The rotation control is a control of causing the gripping member to grip the drain wire with a gripping force increased from that in the squeeze control, and rotating the gripping member around the axis relative to the sheathed portion.

With the drain wire correcting device described above, in the squeeze control, the gripping member is caused to move toward the distal end side of the drain wire while the gripping member is in contact with the drain wire. Thus, it is possible to organize the strands of the drain wire and shape the drain wire straight along the predetermined axis. Moreover, in the rotation control performed after the squeeze control, the gripping member is caused to grip the drain wire with a gripping force increased from that in the squeeze control, and the gripping member is rotated relative to the sheathed portion of the multi-core cable. In the rotation control, the drain wire is gripped more strongly than in the squeeze control, and it is therefore possible to tightly twist the drain wire by the rotation control.

In the squeeze control, the gripping member either grips the drain wire more weakly than in the rotation control, or is merely in contact with the drain wire without gripping the drain wire. Therefore, in the squeeze control, even if the gripping member is moved toward the distal end side of the drain wire, the drain wire is not pulled so strongly. Therefore, the strands of the drain wire are less likely to break. As a result, with the drain wire correcting device described above, it is possible to more desirably correct the drain wire.

In one preferred embodiment of the first drain wire correcting device, the controller is configured to, in the squeeze control, cause the gripping member to grip the drain wire with a gripping force weaker than that in the rotation control.

With the drain wire correcting device described above, in the squeeze control, the drain wire is gripped by the gripping member, and is therefore pulled toward the distal end side. Therefore, it is possible to more desirably shape the drain wire straight.

In one preferred embodiment of the first drain wire correcting device, the controller is configured to, in the rotation control, drive the moving device so that the gripping member pulls the drain wire toward the distal end side of the drain wire.

With the drain wire correcting device described above, in the rotation control, the drain wire is twisted while being pulled toward the distal end side, it is possible to more desirably shape the drain wire straight. Note that at this point, the gripping member may be moving or may not be moving toward the distal end side of the drain wire.

In one preferred embodiment of the first drain wire correcting device, the controller is configured to, after the rotation control, execute a release control. The release control is a control of causing the gripping member to grip the drain wire with a gripping force weaker than that in the rotation control, rotating the gripping member around the axis relative to the sheathed portion, and moving the gripping member along the axis toward the distal end side of the drain wire, thereby releasing the gripping member from the drain wire.

With the drain wire correcting device described above, by the release control of moving the gripping member while rotating the gripping member, it is possible to twist also a portion of the drain wire that has not been twisted in the rotation control (the grip portion that is gripped by the gripping member and a portion on the distal end side relative to the grip portion). Moreover, since the release control is performed until the gripping member comes off the drain wire, the drain wire is twisted up to the distal end by the release control. The gripping force of the gripping member in the release control is weaker than that in the rotation control. Therefore, it is also possible to suppress the problem of the strands of the drain wire being broken.

In one preferred embodiment of the drain wire correcting device, a moving speed of the gripping member relative to the drain wire in the squeeze control is faster than a moving speed of the gripping member relative to the drain wire in the release control.

In the rotation control, in order to twist the drain wire an intended number of times, it is preferred that the rotation speed of the gripping member is associated with the moving speed thereof relative to the drain wire. However, such association is not necessary in the squeeze control. With the drain wire correcting device described above, in the squeeze control, in which there is no need to associate together the rotation speed and the moving speed of the gripping member, the moving speed of the gripping member can be increased so as to save the amount of time required for correcting the drain wire.

In one preferred embodiment of the first drain wire correcting device, the controller executes the rotation control while the gripping member is positioned at the distal end portion of the drain wire.

With the drain wire correcting device described above, the drain wire is twisted while much of the drain wire has been squeezed. Thus, it is possible to more desirably correct the drain wire.

In one preferred embodiment of the first drain wire correcting device, the controller starts the squeeze control while the gripping member is positioned at a root portion of the drain wire.

With the drain wire correcting device described above, since the squeeze control starts from the root portion of the drain wire, where the strands have been relatively organized already before the correction, it is possible to desirably organize the drain wire.

In one preferred embodiment of the first drain wire correcting device, the gripping member includes: a first clamp including a first gripping portion that is notched in a shape corresponding to a cross-sectional shape of the drain wire; and a second clamp including a second gripping portion that is notched in a shape corresponding to the cross-sectional shape of the drain wire and is arranged so as to face the first gripping portion. The drive device is configured to move the first clamp and the second clamp toward or away from each other.

With the drain wire correcting device described above, the drain wire is gripped by a first gripping portion and a second gripping portion that are notched in a shape corresponding to the cross-sectional shape of the drain wire. Therefore, the drain wire is easily organized in the squeeze control, and the drain wire can be easily gripped by the gripping member in the rotation control.

In one preferred embodiment of the first drain wire correcting device, in the squeeze control, the controller may rotate the gripping member around the axis relative to the sheathed portion while moving the gripping member toward the distal end side of the drain wire while the gripping member is in contact with the drain wire.

A second drain wire correcting device according to the present invention includes: a retention device configured to retain a sheathed portion of a multi-core cable, the multi-core cable including the sheathed portion covered with a sheath and a drain wire exposed from the sheathed portion; a squeezing member configured to be in contact with the drain wire so as to surround the drain wire; a gripping member configured to be capable of gripping the drain wire; a drive device configured to drive the gripping member so as to grip or release the drain wire; a moving device configured to move at least one of the multi-core cable retained by the retention device and the squeezing member so that the squeezing member and the sheathed portion move away from each other; a rotating device configured to rotate at least one of the multi-core cable retained by the retention device and the gripping member around a predetermined axis; and a controller configured to control the drive device, the moving device and the rotating device. The controller is configured to execute a squeeze control, and a rotation control after the squeeze control. The squeeze control is a control of moving the squeezing member relative to the multi-core cable while the squeezing member is in contact with the drain wire, thereby squeezing the drain wire toward a distal end side. The rotation control, after the squeeze control, is a control of causing the gripping member to grip the drain wire, and rotating the gripping member around the axis relative to the sheathed portion.

With the drain wire correcting device described above, in the squeeze control, the squeezing member is moved toward the distal end side of the drain wire while the squeezing member is in contact with the drain wire. Therefore, it is possible to organize the strands of the drain wire, and shape the drain wire straight. Moreover, in the rotation control performed after the squeeze control, the drain wire is gripped by the gripping member, and the gripping member is rotated relative to the sheathed portion of the multi-core cable. In the rotation control, the drain wire is gripped by the gripping member, and it is therefore possible to tightly twist the drain wire by the rotation control.

In one preferred embodiment of the second drain wire correcting device, the squeezing member is configured to be capable of gripping the drain wire. The drain wire correcting device further includes another drive device configured to drive the squeezing member so as to grip or release the drain wire based on a control of the controller. In the squeeze control, the controller controls the other drive device so as to cause the squeezing member to grasp the drain wire with a gripping force weaker than the gripping force by which the gripping member grips the drain wire in the rotation control.

With the drain wire correcting device described above, functions and effects similar to those of the embodiment where the drain wire is gripped by the gripping member in the squeeze control can be realized, of those of one preferred embodiment of the first drain wire correcting device.

In one preferred embodiment of the second drain wire correcting device, the drain wire correcting device further includes another moving device configured to move at least one of the multi-core cable retained by the retention device and the gripping member along the axis. The controller is configured to, after the rotation control, execute a release control of causing the gripping member to grip the drain wire with a gripping force weaker than that in the rotation control, rotating the gripping member around the axis relative to the sheathed portion, and driving the other moving device to move the gripping member along the axis toward the distal end side of the drain wire, thereby releasing the gripping member from the drain wire.

With the drain wire correcting device described above, functions and effects similar to the release control of the first drain wire correcting device can be realized.

A drain wire correcting method according to the present invention includes: a first step of retaining a sheathed portion of a multi-core cable, the multi-core cable including the sheathed portion covered with a sheath and a drain wire exposed from the sheathed portion; a second step of causing a gripper, capable of gripping the drain wire, to come into contact with an outer circumference of the drain wire; a third step, after the second step, of moving at least one of the retained multi-core cable and the gripper while the gripper is in contact with the outer circumference of the drain wire, thereby moving the gripper toward a distal end side of the drain wire; a fourth step, after the third step, of causing the gripper to grip the drain wire with a gripping force of the gripper increased from that in the third step; and a fifth step, after the fourth step, of rotating at least one of the retained multi-core cable and the gripper around an axis of the drain wire while the drain wire is gripped by the gripper, thereby rotating the gripper around the axis of the drain wire relative to the sheathed portion.

With the drain wire correcting method described above, functions and effects similar to those of the first drain wire correcting device and the second drain wire correcting device can be realized.

In one preferred embodiment of the drain wire correcting method according to the present invention, in the second step, the drain wire is gripped by the gripper with a gripping force weaker than that in the fourth step and the fifth step.

With the drain wire correcting method described above, functions and effects similar to those of the embodiment where the drain wire is gripped by the gripping member in the squeeze control can be realized, of those of preferred embodiments the first drain wire correcting device and the second drain wire correcting device.

In one preferred embodiment of the drain wire correcting method according to the present invention, the method further includes: a sixth step, after the fifth step, of gripping the drain wire by the gripper with a gripping force weaker than the gripping force in the fourth step and the fifth step; and a seventh step, after the sixth step, of rotating at least one of the retained multi-core cable and the gripper while the drain wire is gripped by the gripper around the axis of the drain wire, thereby rotating the gripper around the axis of the drain wire relative to the sheathed portion, and moving at least one of the retained multi-core cable and the gripper in an axial direction of the drain wire to move the gripper toward the distal end side of the drain wire, thereby releasing the gripper from the drain wire.

With the drain wire correcting method described above, functions and effects similar to those of the embodiment where the release control is executed can be realized, of those of preferred embodiments the first drain wire correcting device and the second drain wire correcting device.

### Effects of Invention

With the drain wire correcting devices or the drain wire correcting method of the present invention, it is possible to correct the drain wire more desirably.

### BRIEF DESCRIPTION OF DRAWINGS

FIG. 1 is a perspective view of a drain wire correcting device according to an embodiment.

FIG. 2 is a left side view of the drain wire correcting device.

FIG. 3 is a perspective view of a first clamp jaw and a second clamp jaw.

FIG. 4 is a cross-sectional view of the main part of the drain wire correcting device immediately before starting to correct the drain wire.

FIG. 5 is a cross-sectional view of the main part of the drain wire correcting device at the start of a squeeze control.

FIG. 6 is a cross-sectional view of the main part of the drain wire correcting device at the end of a squeeze control.

FIG. 7 is a cross-sectional view of the main part of the drain wire correcting device during a rotation control.

FIG. 8 is a cross-sectional view of the main part of the drain wire correcting device at the start of a release control.

FIG. 9 is a cross-sectional view of the drain wire correcting device at the end of a release control.

FIG. 10 is a perspective view of the drain wire correcting device divided into a squeeze device and a twist device.

### DESCRIPTION OF EMBODIMENTS

[Configuration of Drain Wire Correcting Device]

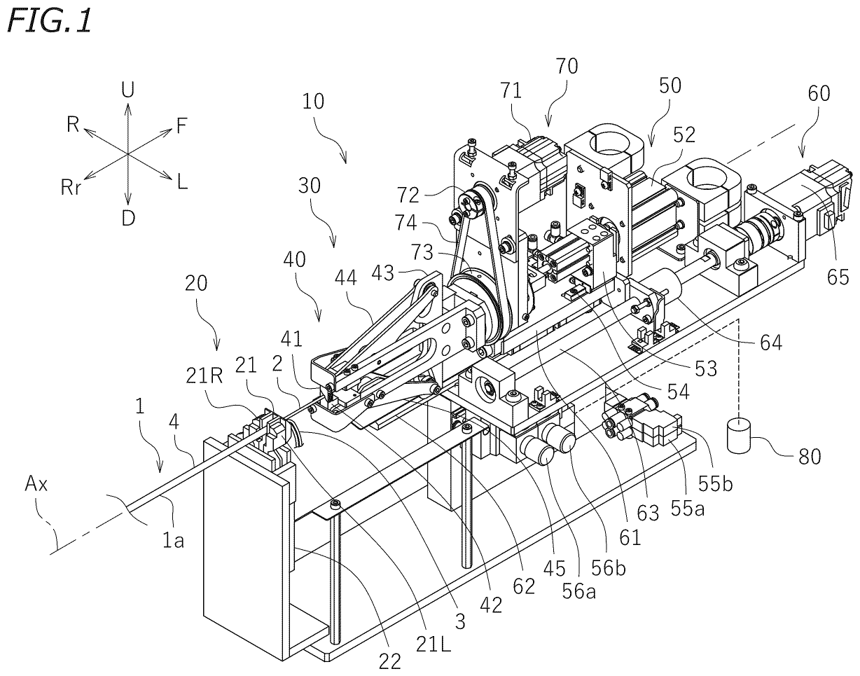

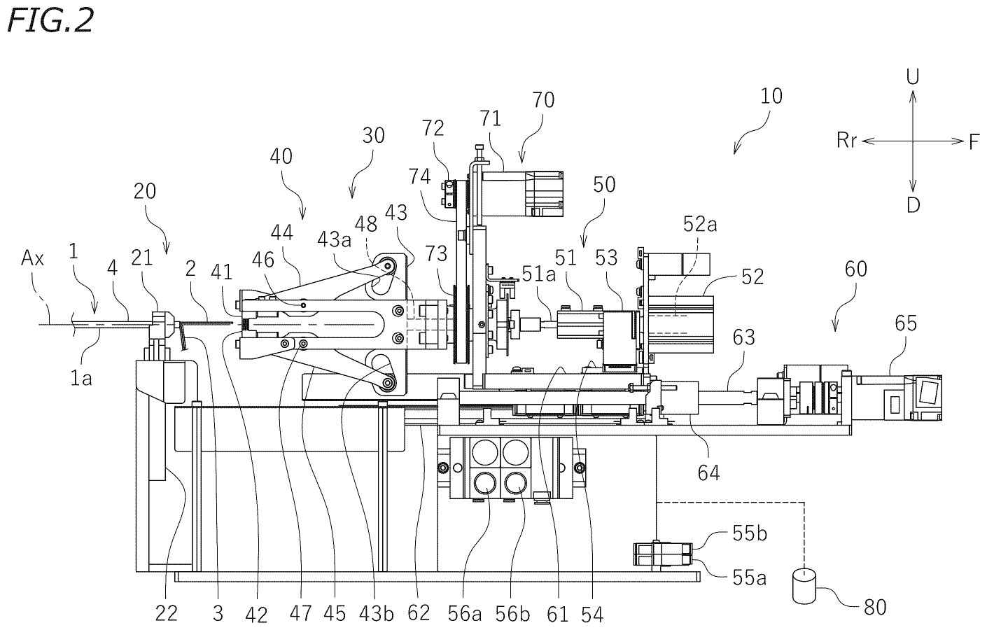

An embodiment of the present invention will now be described with reference to the drawings. FIG. 1 is a perspective view of a drain wire correcting device 10 according to one embodiment. FIG. 2 is a left side view of the drain wire correcting device 10. The drain wire correcting device 10 according to the present embodiment is a device for correcting a drain wire 2 of a multi-core cable 1. Here, “correcting the drain wire 2” means rectifying the drain wire 2 composed of a plurality of metal strands straight and then organize the metal strands so that they do not come apart. Here, the drain wire correcting device 10 is configured to rectify the drain wire 2 straight and then twist the drain wire 2 so that the metal strands do not come apart. The multi-core cable 1 is an electric wire including the drain wire 2, a plurality of core wires 3 and a shield (not shown) covered by a sheath 4. The plurality of core wires 3 are used, for example, as signal wires for transmitting electrical signals. The shield, not shown, is a conductor that shields the core wires 3 from external noise. The shield covers the outside of the plurality of core lines 3. The drain wire 2 is electrically connected to the shield. While in use, the drain wire 2 is grounded, thereby grounding the shield. As described above, the drain wire 2 is composed of a plurality of strands and is not sheathed by an insulator. The plurality of core wires 3 and the drain wire 2 are twisted together inside the shield. The shield is further covered by the insulator sheath 4.

Before being mounted in the drain wire correcting device 10, the multi-core cable 1 is subjected to a process of stripping the sheath 4 at the end, untwisting the plurality of core wires 3 and the drain wire 2 twisted together, and separating the drain wire 2 and the core wires 3. Hereafter, unless otherwise specified, the exposed portion of the drain wire 2 exposed from the sheath 4 will be referred to simply as the drain wire 2 and the exposed portions of the plurality of core wires 3 exposed from the sheath 4 will be referred to simply as the core wires 3. As shown in FIG. 1 and FIG. 2, here, the drain wire 2 and the core wires 3 are separated from each other by bending the plurality of core wires 3 from the axial direction of the multi-core cable 1. Here, the axial direction of the drain wire 2 coincides with the axial direction of a portion of the multi-core cable 1 covered with the sheath 4 (hereinafter referred to also as the sheathed portion 1a). Note however that the axial direction of the drain wire 2 does not need to coincide with the axial direction of the sheathed portion 1a.

As shown in FIG. 1 and FIG. 2, the drain wire correcting device 10 includes a retention device 20, a gripping device 30, a moving device 60, a rotating device 70 and a controller 80. The retention device 20 is configured to retain the sheathed portion 1a of the multi-core cable 1. As shown in FIG. 1, the retention device 20 includes a retention clamp 21 and an actuator 22. The retention clamp 21 includes a pair of retention jaws 21L and 21R. The actuator 22 drives the retention jaws 21L and 21R toward each other or away from each other. The multi-core cable 1 is retained by being sandwiched between the retention jaws 21L and 21R. The multi-core cable 1 is released when the retention jaws 21L and 21R move away from each other.

Note that, in the following description, the side of the multi-core cable 1 in the axial direction on which the drain wire 2 is exposed will be referred to as the distal end side of the multi-core cable 1. The end portion of the drain wire 2 on the distal end side of the multi-core cable 1 is referred to as the distal end of the drain wire 2. In the following, the distal end side of the multi-core cable 1 as retained by the retention device 20 will be referred to as the forward side of the drain wire correcting device 10, and leftward and rightward as viewed from the front side will be referred to as the leftward side and the rightward side, respectively, of the drain wire correcting device 10. In the drawings, F, Rr, L, R, U and D represent front, rear, left, right, up and down of the drain wire correcting device 10, respectively. Note however that these directions are for convenience of explanation and do not in any way limit how the drain wire correcting device 10 is installed, etc.

The gripping device 30 is a mechanism for gripping the drain wire 2 when correcting the drain wire 2. The gripping device 30 is arranged forward of the retention device 20. As shown in FIG. 1, the gripping device 30 includes a gripping clamp 40 and a drive device 50. The gripping clamp 40 includes a first clamp jaw 41 and a second clamp jaw 42 configured to be capable of gripping the drain wire 2. The drive device 50 drives the first clamp jaw 41 and the second clamp jaw 42 so as to grip or release the drain wire 2.

As will be later described in detail, the main part of the gripping clamp 40, including the first clamp jaw 41 and the second clamp jaw 42, is configured by the rotating device 70 to rotate around a predetermined axis Ax. This axis Ax will be hereinafter referred to also as the axis Ax of the gripping clamp 40 or simply as the axis Ax. As will also be later described in detail, the direction of extension of the axis Ax of the gripping clamp 40 is also the direction of movement of the gripping clamp 40 by the moving device 60. As shown in FIG. 2, in the present embodiment, the axis Ax of the gripping clamp 40 coincides with the axis of the sheathed portion 1a of the multi-core cable 1 retained by the retention device 20. The axis Ax also coincides with the axis of the drain wire 2 before being corrected. Note however that the axis Ax of the gripping clamp 40 does not need to coincide with the axis of the sheathed portion 1a of the multi-core cable 1 and the drain wire 2 before being corrected.

As shown in FIG. 2, the gripping clamp 40 includes the first clamp jaw 41, the second clamp jaw 42, a cam plate 43, a first link member 44, a second link member 45, a first rotation axis 46, a second rotation axis 47 and a piston rod 48. The gripping clamp 40 is configured so that when the piston rod 48 is moved in the front-rear direction by the drive device 50, the first clamp jaw 41 and the second clamp jaw 42 move closer to each other or away from each other.

As shown in FIG. 2, the front end of the piston rod 48 is connected to the drive device 50 and the rear end thereof is connected to the cam plate 43. The piston rod 48 is moved in the front-rear direction by the drive device 50. This causes the cam plate 43 to move in the front-rear direction.

As shown in FIG. 1, the cam plate 43 is configured to be in a plate shape. The cam plate 43 extends in the radial direction of the gripping clamp 40 and the front-rear direction. The cam plate 43 includes a pair of long holes 43a and 43b. The first long hole 43a and the second long hole 43b are through holes extending through the cam plate 43 in the left-right direction. As shown in FIG. 2, the first long hole 43a and the second long hole 43b are symmetrical with respect to the axis Ax. The first long hole 43a and the second long hole 43b each extend outward in the radial direction of the gripping clamp 40 as it moves away from the retention device 20 (here, toward the front side of the drain wire correcting device 10) with respect to the direction of extension of the axis Ax.

The first link member 44 and the second link member 45 are provided rearward relative to the cam plate 43 (between the cam plate 43 and the retention device 20). The first link member 44 and the second link member 45 are engaged with the first long hole 43a and the second long hole 43b, respectively. The front end portion of the first link member 44 is pivotably engaged with the first long hole 43a. The center portion of the first link member 44 in the front-rear direction is rotatably supported by the first rotation axis 46 extending in the left-right direction. Similarly, the front end portion of the second link member 45 is pivotably engaged with the second long hole 43b. The center portion of the second link member 45 in the front-rear direction is rotatably supported by the second rotation axis 47 extending in the left-right direction.

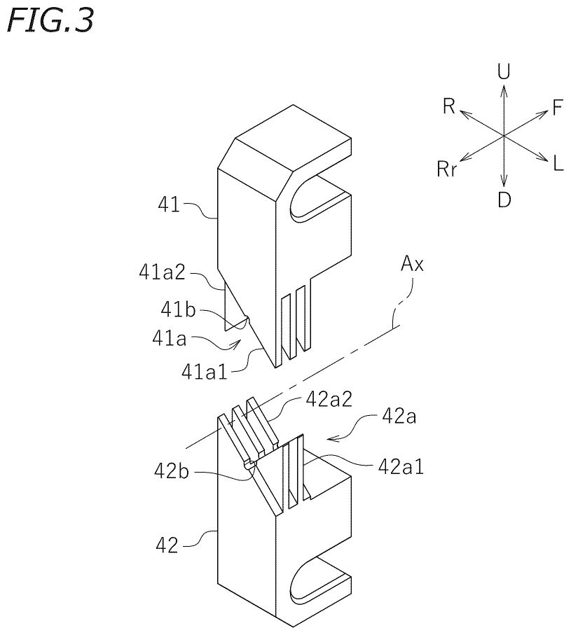

The first clamp jaw 41 and the second clamp jaw 42 are provided at the rear end portions of the first link member 44 and the second link member 45, respectively. The first clamp jaw 41 and the second clamp jaw 42 face each other across the axis Ax of the gripping clamp 40. The first clamp jaw 41 and the second clamp jaw 42 are configured to mesh with each other when they come close to each other by being driven the drive device 50. FIG. 3 is a perspective view of the first clamp jaw 41 and the second clamp jaw 42. FIG. 3 does not show members other than the first clamp jaw 41 and the second clamp jaw 42. As shown in FIG. 3, the first clamp jaw 41 includes a first meshing portion 41a that meshes with the second clamp jaw 42. The first meshing portion 41a includes a plurality of generally triangular comb teeth 41a1 arranged with each other in the front-rear direction, and a plurality of generally triangular comb teeth 41a2 provided adjacent to the plurality of comb teeth 41a1 in the left-right direction and arranged with each other in the front-rear direction. As viewed in the front-rear direction, the comb teeth 41a1 and the comb teeth 41a2 are arranged so that their oblique sides face each other. The comb teeth 41a1 and the comb teeth 41a2 are positioned so as to alternate with each other in the front-rear direction.

The second clamp jaw 42 includes a second meshing portion 42a that meshes with the first meshing portion 41a of the first clamp jaw 41. The second meshing portion 42a also includes a plurality of generally triangular comb teeth 42a1 arranged with each other in the front-rear direction and a plurality of generally triangular comb teeth 42a2 provided adjacent to the plurality of comb teeth 42a1 in the left-right direction and arranged with each other in the front-rear direction. As viewed in the front-rear direction, the comb teeth 42a1 and the comb teeth 42a2 are arranged so that their oblique sides face each other. The comb teeth 42a1 and the comb teeth 42a2 are positioned so as to alternate with each other in the front-rear direction. The comb teeth 42a1 of the second clamp jaw 42 are arranged so as to alternate with the facing comb teeth 41a1 of the first clamp jaw 41. The comb teeth 42a2 of the second clamp jaw 42 are arranged so as to alternate with the facing comb teeth 41a2 of the first clamp jaw 41. Therefore, the first clamp jaw 41 and the second clamp jaw 42 mesh with each other when they come close to each other by being driven by the drive device 50.

The first clamp jaw 41 includes a first gripping portion 41b that is notched in a shape corresponding to the cross-sectional shape of the drain wire 2. Here, the first gripping portion 41b is a generally semicircular notch corresponding to the radius of the drain wire 2 as viewed in the front-rear direction. The first gripping portion 41b is formed where the oblique sides of the comb teeth 41a1 and the oblique sides of the comb teeth 41a2 intersect with each other as viewed in the front-rear direction. The first gripping portion 41b is provided so as to penetrate through the first meshing portion 41a in the front-rear direction.

The second clamp jaw 42 includes a second gripping portion 42b that is notched in a shape corresponding to the cross-sectional shape of the drain wire 2 and arranged so as to face the first gripping portion 41b. The second gripping portion 42b is also notched in a semicircular shape corresponding to the radius of the drain wire 2 as viewed in the front-rear direction. The second gripping portion 42b is formed where the oblique sides of the comb teeth 42a1 and the oblique side of the comb teeth 42a2 intersect with each other as viewed in the front-rear direction. The second gripping portion 42b is provided so as to penetrate through the second meshing portion 42a in the front-rear direction. Therefore, with the first clamp jaw 41 and the second clamp jaw 42 meshed with each other, the first gripping portion 41b and the second gripping portion 42b together form a generally cylindrical gripping portion corresponding to the diameter of the drain wire 2. The axis of the gripping portion formed when the first gripping portion 41b and the second gripping portion 42b mesh with each other coincides with the center of rotation of the gripping clamp 40, i.e., the axis Ax of the gripping clamp 40. Therefore, when the first clamp jaw 41 and the second clamp jaw 42 mesh with each other, the drain wire 2 is gripped on the axis Ax of the gripping clamp 40.

As shown in FIG. 2, the drive device 50 is provided forward relative to the gripping clamp 40. The drive device 50 is connected to the front end portion of the piston rod 48 of the gripping clamp 40, and is configured to move the piston rod 48 in the front-rear direction. As shown in FIG. 2, the drive device 50 includes a first cylinder 51, a second cylinder 52, a support base 53 for the first cylinder 51, a linear guide 54, solenoid valves 55a and 55b provided in the air supply path, not shown, and pressure reducing valves 56a and 56b provided also in the air supply path.

The first cylinder 51 is the first actuator of the drive device 50. The first cylinder 51 is herein an air cylinder with a cylinder rod 51a that extends and retracts in the front-rear direction. Compressed air is supplied to the first cylinder 51 from an air supply path (not shown) for the first cylinder 51. The compressed air supplied or discharged causes the cylinder rod 51a of the first cylinder 51 to extend and retract. The supply or discharge of compressed air to the first cylinder 51 is controlled by the solenoid valve 55a provided in the air supply path. The rear end portion (the distal end portion) of the cylinder rod 51a is connected to the front end portion of the piston rod 48. As the first cylinder 51 extends the cylinder rod 51a, the piston rod 48 is pushed rearward.

The first cylinder 51 is supported by a support base 53. The support base 53 is slidably engaged with the linear guide 54. The linear guide 54 extends in the front-rear direction. The first cylinder 51 is configured to be movable in the front-rear direction along the linear guide 54.

The second cylinder 52 is arranged forward relative to the support base 53. The second cylinder 52 is the second actuator of the drive device 50. Also the second cylinder 52 is herein an air cylinder. Here, the second cylinder 52 is an air cylinder with a larger diameter than the first cylinder 51. The second cylinder 52 includes a cylinder rod 52a that extends and retracts in the front-rear direction. Compressed air is supplied to the second cylinder 52 from an air supply path (not shown) for the second cylinder 52. The compressed air supplied or discharged causes the cylinder rod 52a of the second cylinder 52 to extend and retract. The supply or discharge of compressed air to the second cylinder 52 is controlled by the solenoid valve 55b provided in the air supply path. The rear end portion (the distal end portion) of the cylinder rod 52a is connected to the support base 53.

The axial force with which the first cylinder 51 extends the cylinder rod 51a is adjusted to a predetermined force by the pressure reducing valve 56a provided in the air supply path. The pressure reducing valve 56a is configured to be capable of adjusting the pressure of the compressed air supplied to the first cylinder 51. The axial force with which the second cylinder 52 extends the cylinder rod 52a is adjusted to a predetermined force by the pressure reducing valve 56b provided in the air supply path. Here, the axial force with which the second cylinder 52 extends the cylinder rod 52a is set to be greater than the axial force with which the first cylinder 51 extends the cylinder rod 51a.

The moving device 60 is configured to be capable of supporting the gripping device 30 and moving the gripping device 30 in the front-rear direction along the axis Ax of the gripping clamp 40. The first clamp jaw 41 and the second clamp jaw 42 as gripping members for gripping the drain wire 2 are moved in the front-rear direction by the moving device 60. As shown in FIG. 1, the moving device 60 includes a moving base 61, a linear guide 62, a ball screw 63, a nut 64 and a first motor 65.

The moving base 61 has a gripping device 30 thereon. The moving base 61 supports the gripping device 30. The moving base 61 is slidably engaged with the linear guide 62. The linear guide 62 extends in the front-rear direction. The moving base 61 is configured to be movable in the front-rear direction along the linear guide 62. As the moving base 61 moves in the front-rear direction, the gripping device 30 moves in the front-rear direction. The nut 64 is connected to the moving base 61.

The ball screw 63 meshes with the nut 64. The ball screw 63 is arranged so that the axis is oriented in the front-rear direction. The front end of the ball screw 63 is connected to the first motor 65. When the first motor 65 is driven, the ball screw 63 rotates around the axis. As the ball screw 63 rotates around the axis, the moving base 61 moves along the linear guide 62 via the nut 64 meshed with the ball screw 63. The moving device 60 can change the speed at which the gripping device 30 is moved in the front-rear direction by changing the rotation speed of the first motor 65.

The rotating device 70 is a mechanism for rotating the gripping clamp 40 around the axis Ax. The first clamp jaw 41 and the second clamp jaw 42 as gripping members that grip the drain wire 2 are rotated around the axis Ax by the rotating device 70. The rotating device 70 is mounted on the moving base 61 of the moving device 60 together with the gripping device 30. The rotating device 70 moves in the front-rear direction together with the gripping device 30. As shown in FIG. 1, the rotating device 70 includes a second motor 71, a motor-side pulley 72, a clamp-side pulley 73 and a timing belt 74.

The second motor 71 is provided upward relative to the gripping clamp 40. The main shaft of the second motor 71 extends in the front-rear direction. The main shaft of the second motor 71 rotates around an axis parallel to the axis Ax of the gripping clamp 40. The motor-side pulley 72 is connected to the main shaft of the second motor 71. The clamp-side pulley 73 is connected to gripping clamp 40. The timing belt 74 is an endless belt and is wound around the motor-side pulley 72 and the clamp-side pulley 73. The rotational force of the second motor 71 is transmitted to the gripping clamp 40 via the motor-side pulley 72, the timing belt 74 and the clamp-side pulley 73. When the second motor 71 is driven, the gripping clamp 40 rotates around the axis Ax. The rotating device 70 may be configured to be capable of changing the speed at which the gripping device 30 is rotated by changing the rotational speed of the second motor 71.

As shown in FIG. 1, the drain wire correcting device 10 includes a controller 80. The controller 80 controls the retention device 20, the drive device 50 of the gripping device 30, the moving device 60 and the rotating device 70. The controller 80 is connected to the actuator 22, the solenoid valve 55a for the first cylinder 51, the solenoid valve 55b for the second cylinder 52, the first motor 65 and the second motor 71, and controls their operation.

There is no particular limitation on the configuration of the controller 80. For example, the controller 80 may be equipped with a central processing unit (hereinafter referred to as “CPU”), a ROM storing therein programs and the like to be executed by the CPU, a RAM, etc. Each section of the controller 80 may be implemented as software or implemented as hardware. Each section may be a processor or may be a circuit. The controller 80 may be, for example, a programmable controller, a computer, or the like. How the operation of each section is controlled by the controller 80 will be described in the following description of the process of correcting the drain wire 2.

[Drain Wire Correcting Process]

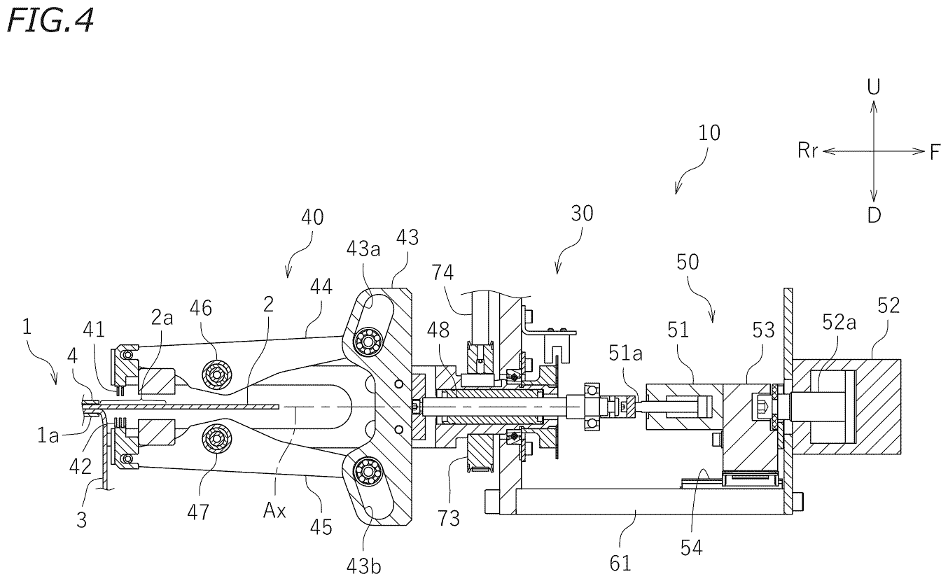

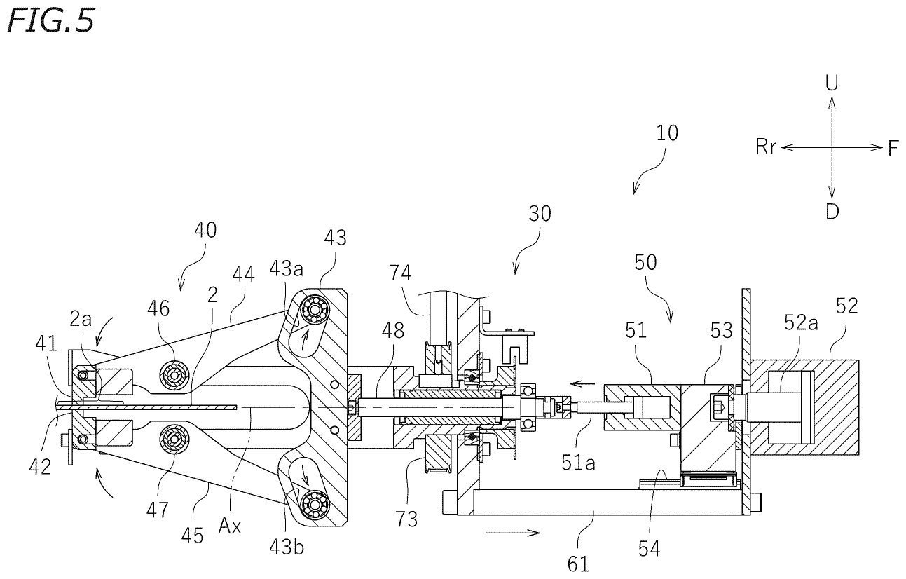

The process of correcting the drain wire 2 will be described below. FIG. 4 is a cross-sectional view of the main part of the drain wire correcting device 10 immediately before starting to correct the drain wire 2. FIG. 4 does not show some of the members. This similarly applies also to FIG. 5 to FIG. 9. As shown in FIG. 4, before starting to correct the drain wire 2, the drain wire correcting device 10 drives the moving device 60 (see FIG. 1) to move the gripping device 30 rearward. Thus, substantially the entire drain wire 2 is moved forward relative to the first clamp jaw 41 and the second clamp jaw 42. Immediately before starting to correct the drain wire 2, substantially the entire drain wire 2 is contained in the space between the first link member 44 and the second link member 45. Note that while it is the gripping device 30 that actually moves in the above description, the change in the positional relationship between different members may be expressed, as needed, also as the movement of a member that does not actually move. As shown in FIG. 4, the first clamp jaw 41 and the second clamp jaw 42 are separated from each other at this time. The state in which the first clamp jaw 41 and the second clamp jaw 42 are separated will hereinafter be referred to also as the gripping clamp 40 being open.

When the correcting of the drain wire 2 is started, the drain wire correcting device 10 first controls the drive device 50 of the gripping device 30 to mesh together the first clamp jaw 41 and the second clamp jaw 42. Thus, the first clamp jaw 41 and the second clamp jaw 42 grip the drain wire 2 on the axis Ax of the gripping clamp 40. FIG. 5 is a cross-sectional view of the main part of the drain wire correcting device 10 at the start of correcting the drain wire 2. As shown in FIG. 5, at this time, the cylinder rod 51a of the first cylinder 51 is extended. The cylinder rod 51a is pushing the piston rod 48 toward the rear side. The piston rod 48 is moved more rearward from the state shown in FIG. 4.

As the piston rod 48 moves rearward, the cam plate 43 connected to the piston rod 48 also moves rearward. As shown in FIG. 4 and FIG. 5, as the cam plate 43 moves rearward, the rear end portions of the first link member 44 and the second link member 45 move outward in the radial direction of the gripping clamp 40 along the first long hole 43a and the second long hole 43b, respectively. Thus, the first link member 44 and the second link member 45 rotate around the first rotation axis 46 and the second rotation axis 47, respectively. Thus, the first clamp jaw 41 and the second clamp jaw 42 provided at the rear end portions of the first link member 44 and the second link member 45, respectively, move inward in the radial direction of the gripping clamp 40. As a result, the first clamp jaw 41 and the second clamp jaw 42 grip the drain wire 2.

In the state shown in FIG. 5, the drain wire 2 is gripped by the first gripping portion 41b (see FIG. 3) of the first clamp jaw 41 and the second gripping portion 42b (see FIG. 3) of the second clamp jaw 42. Even if the drain wire 2 is not positioned between the first gripping portion 41b and the second gripping portion 42b while the first clamp jaw 41 and the second clamp jaw 42 are coming close to each other, the drain wire 2 is guided between the first gripping portion 41b and the second gripping portion 42b by the oblique sides of the comb teeth 41a1, 41a2, 42a1 or 42a2. As shown in FIG. 5, at this point, the first clamp jaw 41 and the second clamp jaw 42 grip a root portion 2a of the drain wire 2. Here, the root portion 2a of the drain wire 2 means, for example, a portion that is closer to the sheathed portion 1a than one third of the exposed length of the drain wire 2 in the axial direction, and more preferably, a portion that is closer to the sheathed portion 1a than one fifth of the exposed length of the drain wire 2 in the axial direction.

As shown in FIG. 5, in this state, the gripping force of the gripping clamp 40 is generated by the driving force of the first cylinder 51. Hereinafter, the gripping of the drain wire 2 by the driving force of the first cylinder 51 will be referred to also as “weak grip”, and such a gripping action of the drain wire 2 will be referred to also as “to weakly grip”. The degree of gripping force in the case of the weak grip will be described below.

In the state shown in FIG. 5, the first gripping portion 41b and the second gripping clamp 42b are in contact with the drain wire 2 with respect to the direction in which the first clamp jaw 41 and the second clamp jaw 42 move toward and away from each other. As the first meshing portion 41a and the second meshing portion 42a mesh with each other, the first clamp jaw 41 and the second clamp jaw 42 stop by hitting the drain wire 2 for the direction in which the first clamp jaw 41 and the second clamp jaw 42 move toward and away from each other. The first gripping portion 41b and the second gripping portion 42b are notched in a shape corresponding to the cross-sectional shape of the drain wire 2. Therefore, the first clamp jaw 41 and the second clamp jaw 42 are in contact with or at least close to the drain wire 2 for directions except for the direction in which the first clamp jaw 41 and the second clamp jaw 42 move toward and away from each other.

In the next step, with the first clamp jaw 41 and the second clamp jaw 42 in contact with the drain wire 2, the moving device 60 is driven to move the first clamp jaw 41 and the second clamp jaw 42 toward the distal end side (herein, forward) of the drain wire 2. The control in the previous step of bringing the first clamp jaw 41 and the second clamp jaw 42 into contact with the drain wire 2, and the control in this step will hereinafter be collectively referred to also as “squeeze control”. The controller 80 according to the present embodiment controls the drive device 50 and the moving device 60 to perform the squeeze control.

In the squeeze control, the first gripping portion 41b of the first clamp jaw 41 and the second gripping portion 42b of the second clamp jaw 42 move along the axis Ax of the gripping clamp 40 while being in contact with the outer circumference of the drain wire 2 (specifically, while weakly gripping the drain wire 2). Thus, the drain wire 2 is squeezed toward the distal end side, thereby organizing a plurality of strands of the drain wire 2. As a result of the squeeze, the drain wire 2 is shaped straight. At this time, the first clamp jaw 41 and the second clamp jaw 42 are weakly gripping the drain wire 2. Therefore, when moving the gripping clamp 40 along the drain wire 2, there is easily slippage between the first clamp jaw 41 and the second clamp jaw 42 and the drain wire 2. The gripping force of the gripping clamp 40 while weakly gripping is set to such a gripping force that there is easily slippage between the first clamp jaw 41 and the second clamp jaw 42 and the drain wire 2 and the drain wire 2 is not pulled excessively.

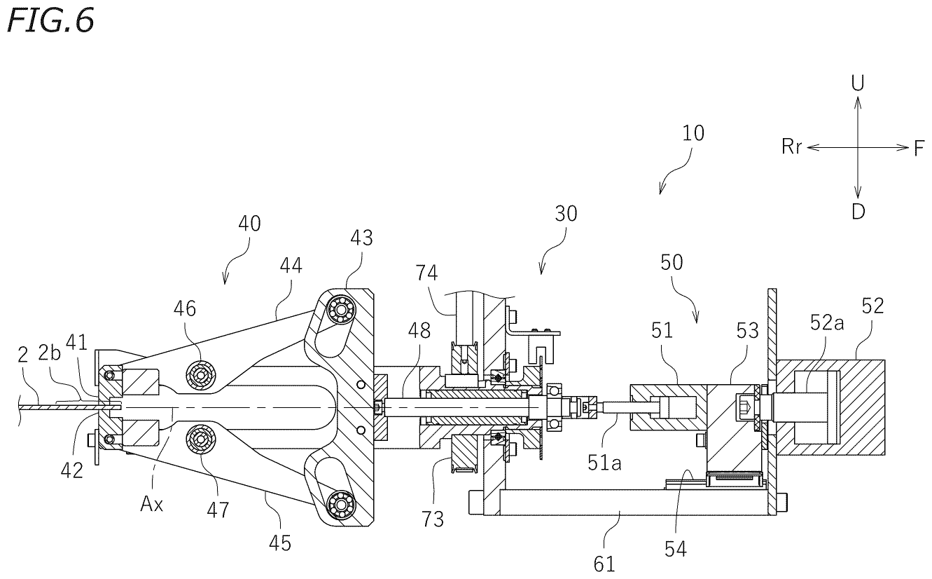

FIG. 6 is a cross-sectional view of the main part of the drain wire correcting device 10 at the end of a squeeze control. As shown in FIG. 6, in the squeeze control, the gripping device 30 is moved until the first clamp jaw 41 and the second clamp jaw 42 reach the distal end portion 2b of the drain wire 2. The distal end portion 2b of the drain wire 2 herein means, for example, a portion that is closer to the distal end than one third of the exposed length of the drain wire 2 in the axial direction, and more preferably, a portion that is closer to the distal end than one fifth of the exposed length of the drain wire 2 in the axial direction. As the squeezing of the drain wire 2 by the squeeze control is performed from the root portion 2a to the distal end portion 2b of the drain wire 2, the strands of the substantial portion of the drain wire 2 are organized and shaped straight.

In the next step, the drain wire 2 is gripped by the first clamp jaw 41 and the second clamp jaw 42 with the gripping force increased from that during the squeeze control. Further in the next step, the rotating device 70 is driven to rotate the first clamp jaw 41 and the second clamp jaw 42, gripping the drain wire 2, around the axis Ax of the gripping clamp 40. The control of making the first clamp jaw 41 and the second clamp jaw 42 strongly grip the drain wire 2, and the control of rotating the first clamp jaw 41 and the second clamp jaw 42 will hereinafter be collectively referred to also as “rotation control”. The controller 80 is configured to execute the rotation control after the squeeze control. The controller 80 executes the rotation control with the first clamp jaw 41 and the second clamp jaw 42 positioned at the distal end portion 2b of the drain wire 2.

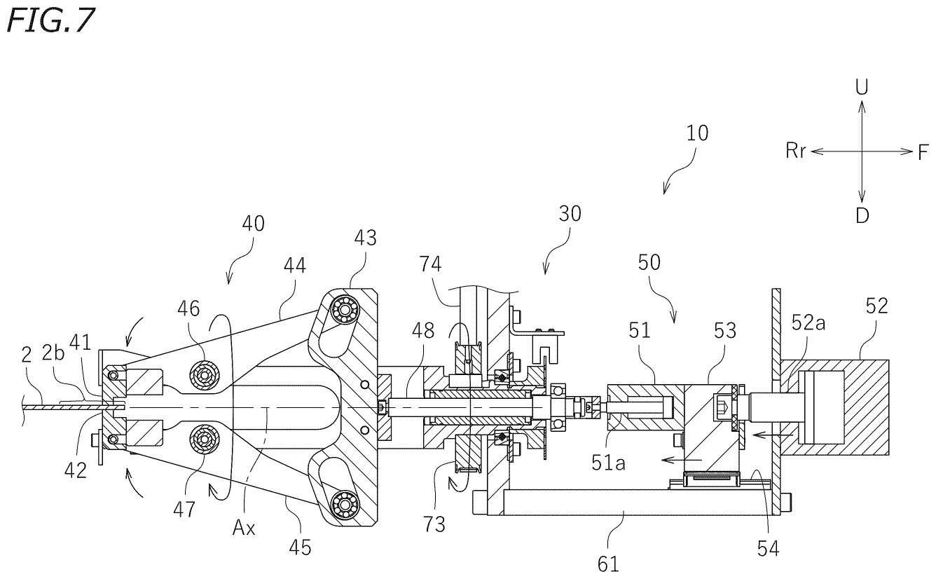

FIG. 7 is a cross-sectional view of the main part of the drain wire correcting device 10 during the rotation control. As shown in FIG. 7, the cylinder rod 52a of the second cylinder 52 is extended at this time. The support base 53 is pushed by the second cylinder 52 and is moved rearward relative to the state shown in FIG. 4 to FIG. 6, in other words, the weak grip state. The second cylinder 52 is pressing the first cylinder 51 rearward via the support base 53. As a result, the second cylinder 52 presses the piston rod 48 rearward via the first cylinder 51. The gripping force of the gripping clamp 40 at this time is generated by the driving force of the second cylinder 52.

The axial force of the second cylinder 52 is set to be greater than the axial force of the first cylinder 51. Therefore, in the state shown in FIG. 7, the gripping force by which the first clamp jaw 41 and the second clamp jaw 42 grip the drain wire 2 is greater than that in the state shown in FIG. 4 to FIG. 6 (the weakly gripping state). Hereinafter, the gripping of the drain wire 2 by the driving force of the second cylinder 52 will be referred to also as “strong grip” and such a drain wire 2 gripping action will be referred to also as “to strongly grip”. Note that the first cylinder 51 may be driven or may not be driven at this time.

The rotation control further rotates the first clamp jaw 41 and the second clamp jaw 42, gripping the drain wire 2, around the axis Ax of the gripping clamp 40. When rotating the first clamp jaw 41 and the second clamp jaw 42, the second motor 71 (see FIG. 2) of the rotating device 70 is driven. The first clamp jaw 41 and the second clamp jaw 42, strongly gripping the drain wire 2, rotate around the axis Ax, thereby twisting the drain wire 2. The gripping force of the gripping device 30 gripping strongly is set to such a gripping force that there is no slippage between the first clamp jaw 41 and the second clamp jaw 42 and the drain wire 2 when the gripping clamp 40 is rotated. This allows the drain wire 2 to be twisted the same number of times as the number of times set in the controller 80. In addition, by tightening the drain wire 2 by the rotation control, it is possible to stably retain the shape of the drain wire 2 formed straight by the squeeze control. The rotation control can correct a portion of the drain wire 2 that is on the sheathed portion 1a side than the portion gripped by the first clamp jaw 41 and the second clamp jaw 42.

In the rotation control, the controller 80 may drive the moving device 60 so that the first clamp jaw 41 and the second clamp jaw 42 pull the drain wire 2 toward the distal end side. The driving force of the moving device 60 at this time should be such that the gripping clamp 40 does not move forward. Note however that the gripping clamp 40 may move against the drain wire 2 by the driving force of the moving device 60 in the rotation control. In the present embodiment, the moving device 60 is not driven in the rotation control, and the first clamp jaw 41 and the second clamp jaw 42 do not actively pull the drain wire 2 toward the distal end side, but the twisting urges the drain wire 2 to shrink, resulting in a tension on the drain wire 2 that pulls toward the distal end side.

In the next step, the gripping force of the first clamp jaw 41 and the second clamp jaw 42 is switched to a gripping force that is weaker than the gripping force in the rotation control. Here, the gripping of the first clamp jaw 41 and the second clamp jaw 42 is switched to the same weak grip as that in the squeeze control. Note however that the gripping force of the gripping clamp 40 at this time may be a third gripping force that is set to be weaker than that in the rotation control. The drain wire correcting device 10 may be configured so that the gripping force of the gripping clamp 40 can be set to the third gripping force. Further, in the next step, the first clamp jaw 41 and the second clamp jaw 42 are moved along the axis Ax toward the distal end side of the drain wire 2 while being rotated around the axis Ax of the gripping clamp 40. This releases the first clamp jaw 41 and the second clamp jaw 42 from the drain wire 2. Hereafter, these two control steps are will be referred to collectively as the “release control”. The controller 80 is configured to execute the release control after the rotation control.

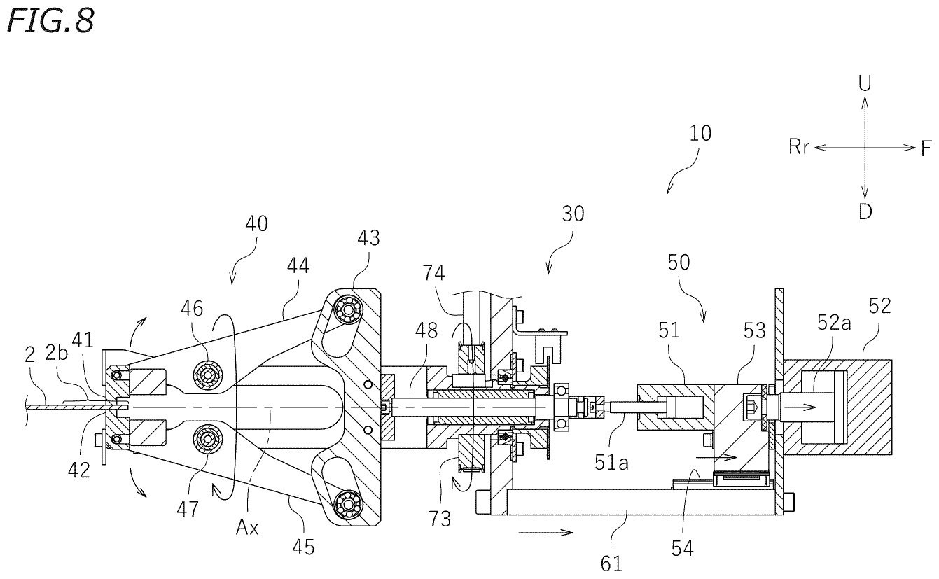

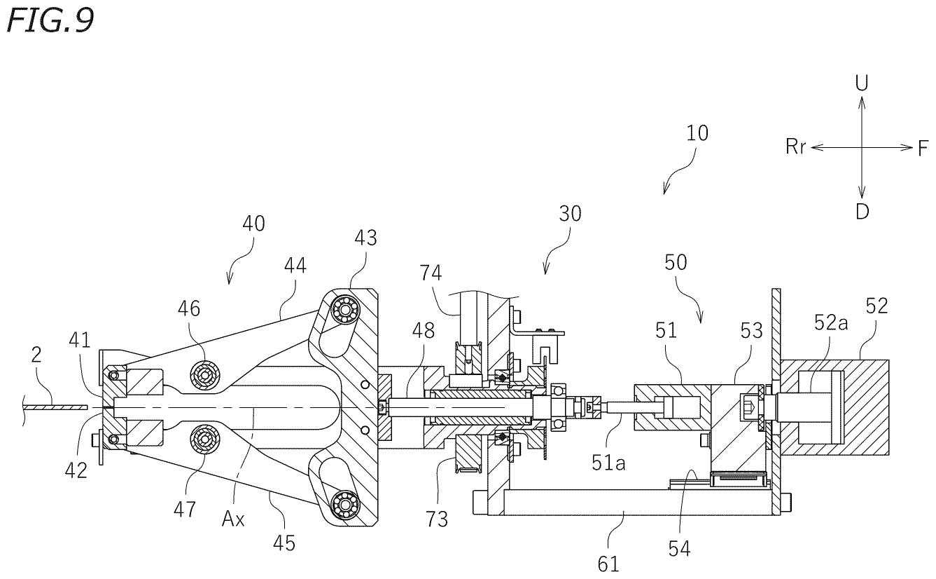

FIG. 8 is a cross-sectional view of the main part of the drain wire correcting device 10 at the start of the release control. FIG. 9 is a cross-sectional view of the main part of the drain wire correcting device 10 at the end of the release control. As shown in FIG. 8, in the release control, as in the squeeze control, the gripping clamp 40 is driven by the first cylinder 51 and the second cylinder 52 is not used. Thus, the gripping clamp 40 weakly grips the drain wire 2. In the release control, the gripping clamp 40 is rotated around the axis Ax. Moreover, in the release control, the gripping clamp 40 is moved toward the distal end side of the drain wire 2.

In the release control, the first clamp jaw 41 and the second clamp jaw 42 twist the drain wire 2 while slipping slightly against the drain wire 2, and move the position at which the drain wire 2 is gripped toward the distal end side the drain wire 2. While the position at which the drain wire 2 is gripped by the first clamp jaw 41 and the second clamp jaw 42 is the starting point for correcting the drain wire 2, part of the drain wire 2 that is at the gripping position or on the distal end side relative to the gripping position is not corrected. Therefore, in the release control, the gripping position of the drain wire 2 is moved to the distal end side while twisting the drain wire 2. This gradually reduces the uncorrected portion of the drain wire 2. As shown in FIG. 9, when the first clamp jaw 41 and the second clamp jaw 42 are released from the drain wire 2, the entire drain wire 2 will have been corrected.

In the release control, the drain wire 2 is gripped weakly so that the drain wire 2 is not pulled excessively as the gripping clamp 40 moves. In the release control, it is preferred that the rotation speed and the moving speed of the gripping clamp 40 are associated with each other in order to control the number of times the drain wire 2 is twisted. Therefore, in the release control, the gripping clamp 40 is moved at a slower speed than in the squeeze control. In the squeeze control, the gripping clamp 40 is moved at a higher speed than in the release control, because the rotation speed and the moving speed of the gripping clamp 40 do not need to be associated with each other.

[Functions/Effects of Embodiment]

Hereinbelow, the functions and effects of the drain wire correcting device 10 according to the present embodiment will be described, including the findings obtained by the present inventors in the process of arriving at the process of correcting the drain wire 2 described above.

With the drain wire correcting device 10 according to the present embodiment, the squeeze control is executed to move the first clamp jaw 41 and the second clamp jaw 42 toward the distal end side of the drain wire 2, with the first clamp jaw 41 and the second clamp jaw 42 as gripping members being in contact with the drain wire 2. After the squeeze control, the rotation control is executed, in which the first clamp jaw 41 and the second clamp jaw 42 are caused to grip the drain wire 2 with a stronger gripping force than during the squeeze control while the first clamp jaw 41 and the second clamp jaw 42 are rotated around the axis Ax of the gripping clamp 40 (in other words, around the axis of the drain wire 2 after the squeeze control). With such a drain wire correcting device 10, in the squeeze control, the strands of the drain wire 2 can be organized and the drain wire 2 can be shaped straight. Furthermore, in the rotation control performed after the squeeze control, the gripping clamp 40 is rotated while the drain wire 2 is gripped more strongly than in the squeeze control. Therefore, by the rotation control, it is possible to tightly twist the drain wire 2.

In the squeeze control, the first clamp jaw 41 and the second clamp jaw 42 grip the drain wire 2 more weakly than in the rotational control. Therefore, even if the first clamp jaw 41 and the second clamp jaw 42 are moved toward the distal end side of the drain wire 2 in the squeeze control, the drain wire 2 is not pulled so strongly. Therefore, the strands of the drain wire 2 are less likely to break.

Where a drain wire is not corrected, for example, several problems arise when attempting to insert the drain wire into a heat-shrink tube. A drain wire that has not been corrected still has kinks from when it was twisted in the sheath, and unless these kinks are corrected, it is difficult to insert the drain wire into the heat-shrink tube. Moreover, strands of a drain wire that has not been corrected are scattered, and if they are not organized, it is difficult to insert the drain wire into the heat-shrink tube. Furthermore, when a force in the axial direction is applied while inserting an uncorrected drain wire into a heat-shrink tube, the drain wire buckles easily. Therefore, it is preferable that the drain wire be shaped straight and be tightly twisted (corrected).

According to the findings of the present inventors, when correcting the drain wire, if the root portion of the drain wire is first gripped by the gripping member and then the gripping member is rotated while moving the gripping member toward the distal end side of the drain wire, strands that were separated from, and not organized with, other strands are likely to be wound around the outer circumference of the twisted wire of the other strands. Those strands that are wound around the outer circumference of the twisted wire are likely to cause problems in subsequent processes. Specifically, for example, strands wound around the outer circumference cause unevenness on the outer circumference of the drain wire, which is likely to increase the insertion resistance when inserting the heat-shrink tube to the drain wire. Furthermore, for example, the strands wound around the outer circumference are shorter than other strands, which is likely to cause defects when crimping a crimp terminal to the drain wire. When the drain wire is twisted while moving the grip portion, the drain wire is not twisted tightly because of the slippage between the drain wire and the gripping member. Therefore, the drain wire is likely to buckle. Therefore, according to the findings of the present inventors, it is preferred that the drain wire is twisted after squeezing the drain wire and organizing strands.

Furthermore, according to the findings of the present inventors, if the drain wire is only squeezed and not twisted, the strands, especially in the distal end portion of the drain wire, are likely not to be organized but remain scattered. If the drain wire is only twisted but not squeezed, kinks of the drain wire are likely to remain uncorrected.

The drain wire correcting device 10 according to the present embodiment is set to execute the rotation control after executing the squeeze control. Therefore, problems described above can be suppressed. Furthermore, the drain wire correcting device 10 according to the present embodiment executes the rotation control while the first clamp jaw 41 and the second clamp jaw 42 are positioned at the distal end portion 2b of the drain wire 2. Therefore, it is possible to twist the drain wire 2 while most of the drain wire 2 has been squeezed. Therefore, it is possible to more desirably correct the drain wire 2.

According to the findings of the present inventors, if the gripping force of the gripping member is made strong when squeezing the drain wire, the strands of the drain wire are likely to be broken due to excessive pulling. Or the drain wire is likely to be damaged. With the drain wire correcting device 10 according to the present embodiment, the gripping force by which the gripping clamp 40 grips the drain wire 2 during the squeeze control is set to be weaker than the gripping force by which the gripping clamp 40 grips the drain wire 2 during the rotation control. Therefore, it is possible to suppress the problem of the strands of the drain wire 2 being broken or the drain wire 2 being damaged. In the rotation control, the drain wire 2 is gripped more strongly than in the squeeze control, and it is therefore possible to tightly twist the drain wire 2 by the rotation control.

In the present embodiment, in the squeeze control, the controller 80 causes the first clamp jaw 41 and the second clamp jaw 42 to grip the drain wire 2 with a weaker gripping force than in the rotation control. In other words, in the squeeze control, the controller 80 does not bring the first clamp jaw 41 and the second clamp jaw 42 to a state where the first clamp jaw 41 and the second clamp jaw 42 are only in contact with, but do not grip, the drain wire 2. Thus, the drain wire 2 is pulled toward the distal end side by the first clamp jaw 41 and the second clamp jaw 42. Therefore, the drain wire 2 can be more desirably shaped straight.

Furthermore, in the present embodiment, the controller 80 starts the squeeze control when the first clamp jaw 41 and the second clamp jaw 42 are positioned at the root portion 2a of the drain wire 2. With such a configuration, since the squeeze control starts from the root portion 2a of the drain wire 2, where the strands have been relatively organized already before the correction, it is possible to desirably organize the drain wire 2. With such a squeeze control, most of the drain wire 2 from the root portion 2a to the distal end portion 2b can be squeezed.

With the drain wire correcting device 10 according to the present embodiment, in the release control after the rotation control, the controller 80 causes the first clamp jaw 41 and the second clamp jaw 42 to grip the drain wire 2 with a weaker gripping force than in the rotation control, and are rotated around the axis Ax of the gripping clamp 40. Furthermore, the controller 80 moves the first clamp jaw 41 and the second clamp jaw 42 toward the distal end side of the drain wire 2, thereby releasing the first clamp jaw 41 and the second clamp jaw 42 from the drain wire 2. With such a release control, by moving, while rotating, the first clamp jaw 41 and the second clamp jaw 42, the portion of the drain wire 2 that is not twisted in the rotation control, i.e., the grip portion that is gripped by the first clamp jaw 41 and the second clamp jaw 42 and a portion on the distal end side relative to the grip portion, can also be twisted. Furthermore, since the release control is performed until the first clamp jaw 41 and the second clamp jaw 42 come off the drain wire 2, the drain wire 2 can be twisted to the distal end thereof by the release control. The gripping force of the gripping clamp 40 during the release control is weaker than that during the rotation control. Therefore, it is possible to suppress the problem of the strands of the drain wire 2 being broken.

With the drain wire correcting device 10 according to the present embodiment, the moving speed of the first clamp jaw 41 and the second clamp jaw 42 relative to the drain wire 2 in the squeeze control is faster than the moving speed of the first clamp jaw 41 and the second clamp jaw 42 relative to the drain wire 2 in the release control. Such a control saves the amount of time required for correcting the drain wire 2.

With the drain wire correcting device 10 according to the present embodiment, the first clamp jaw 41 includes the first gripping portion 41b that is notched in a shape corresponding to the cross-sectional shape of the drain wire 2, and the second clamp jaw 42 includes the second gripping portion 42b that is notched in a shape corresponding to the cross-sectional shape of the drain wire 2 and is arranged so as to face the first gripping portion 41b. With such a configuration, the drain wire 2 is gripped by the first gripping portion 41b and the second gripping portion 42b, which are notched in a shape corresponding to the cross-sectional shape of the drain wire 2. Therefore, the drain wire 2 can be easily organized in the squeeze control, and the drain wire 2 can be easily gripped in the rotation control.

Note that the controller 80 may drive the moving device 60 so that the first clamp jaw 41 and the second clamp jaw 42 pull the drain wire 2 toward the distal end side in the rotation control. In this case, since the drain wire 2 is twisted while being pulled toward the distal end side during the rotation control, the drain wire 2 can be more desirably shaped straight. Furthermore, it has been confirmed by the present inventors that such a control can increase the strength of binding of the twisted drain wire 2.

### OTHER EMBODIMENTS

One embodiment of the present invention has been described above. Note however that the embodiment above is only an example, and various other embodiments are possible. For example, in the embodiment described above, the release control is performed to release the gripping clamp 40 from the drain wire 2 while rotating the gripping clamp 40, but the release control does not need to be performed. The present inventors have confirmed that even if the gripping clamp 40 is opened immediately after the rotation control, there is only a problem that the convergence of a portion of the drain wire 2 that is gripped by the gripping clamp 40 is slightly weak. Instead of the release control, the gripping clamp 40 may be rotated without moving the gripping clamp 40 while the drain wire 2 is weakly gripped. Also in this case, there is slippage between the drain wire 2 and the first clamp jaw 41 and the second clamp jaw 42, and it is possible to twist a portion of the drain wire 2 that has not been twisted since it has been gripped by the first clamp jaw 41 and the second clamp jaw 42 in the rotation control.

Although the gripping clamp 40 does not rotate in the squeeze control in the embodiment described above, the gripping clamp 40 may rotate. Although the gripping clamp 40 weakly grips the drain wire 2 in the squeeze control in the embodiment described above, the gripping clamp 40 may only be in contact with the drain wire 2 and not grip the drain wire 2.

The configuration of the drain wire correcting device is not limited to those described above. For example, the drain wire correcting device may rotate the multi-core cable retained by the retention device around a predetermined axis instead of the gripping device. Alternatively, the drain wire correcting device may rotate both the gripping device and the multi-core cable around a predetermined axis, thereby rotating the drain wire relative to the sheathed portion of the multi-core cable. Similarly, the drain wire correcting device may move the multi-core cable retained by the retention device, but not the gripping device, in the axial direction of the gripping device. Alternatively, the drain wire correcting device may be configured to move both the gripping device and the multi-core cable in the axial direction of the gripping device, thereby squeezing the drain wire toward the distal end side.

Other than the above, unless otherwise specified, the embodiment described above does not limit the present invention. For example, the gripping force of the gripping device may be switched by switching the pressure of the air supplied to one air cylinder. The actuator of the gripping device does not need to be an air-driven actuator. There is no particular limitation on the configuration of the gripping device as long as the gripping force can be switched between strong and weak. There is also no limitation on the retention device, the moving device and the rotating device.

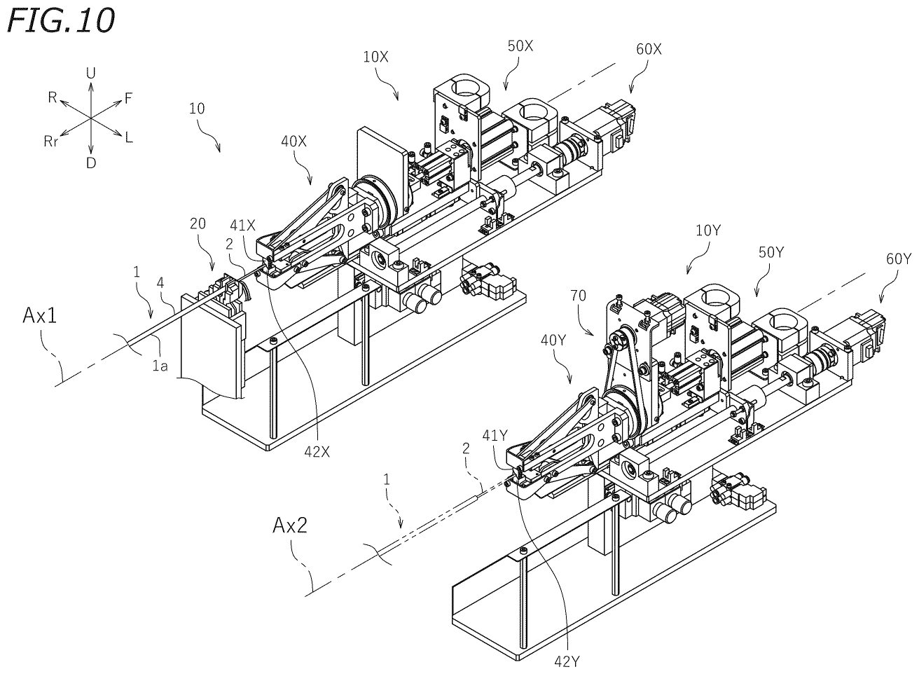

According to another suitable embodiment, the drain wire correcting device may be divided into a device for performing the squeeze control and a device for performing the rotating control and the release control. FIG. 10 is a perspective view of the drain wire correcting device 10, which is divided into a squeeze device 10X and a twist device 10Y. As shown in FIG. 10, in this embodiment, the squeeze device 10X and the twist device 10Y are installed side by side. Although not shown in the figures, the retention device 20, which retains the multi-core cable 1, is configured to move or swivel to hand over the multi-core cable 1 that has been processed by the squeeze device 10X to the twist device 10Y (the multi-core cable 1 after being moved is shown by a two-dot-chain line). The operation of the retention device 20, the squeeze device 10X and the twist device 10Y is controlled by the controller 80 (see FIG. 1). The controller 80 may be arranged distributed among the retention device 20, the squeeze device 10X and the twist device 10Y, or it may be centralized in one location.

As shown in FIG. 10, the squeeze device 10X includes a first gripping clamp 40X, a first drive device 50X and a first moving device 60X. The configuration of the first gripping clamp 40X, the first drive device 50X and the first moving device 60X may be similar to the configuration of the gripping clamp 40, the drive device 50 and the moving device 60, respectively, of the embodiment described first. The first drive device 50X drives the clamp jaws 41X and 42X of the first gripping clamp 40X so as to grip or release the drain wire 2. The first drive device 50X is configured to at least allow the first gripping clamp 40X to weakly grip the drain wire 2. The gripping force of the first gripping clamp 40X generated by the first drive device 50X does not need to be changeable from the gripping force of the weak grip. The first moving device 60X is configured to move the first gripping clamp 40X along the axis Ax. Thus, the first moving device 60X moves the first gripping clamp 40X away from the sheathed portion 1a of the multi-core cable 1. The operation of the squeeze control by the squeeze device 10X may be the same as in the first embodiment. Alternatively, the squeeze control by the squeeze device 10X may squeeze up to the distal end of the drain wire 2. Note that while the squeeze device 10X does not include a rotating device in this embodiment, it may include a rotating device and perform the squeeze control while rotating the first gripping clamp 40X.

In this embodiment, the gripping device 10X does not need to strongly grip the drain wire 2. Therefore, the gripping device 10X may include a squeezing member (e.g., a squeezing jaw) that comes into contact with the drain wire 2 so as to surround the drain wire 2, instead of a first gripping clamp 40X that grips the drain wire 2. Such a squeezing member may be configured to be non-movable in a direction toward or away from the drain wire 2. Needless to say, the squeezing device 10X may, as in this embodiment, include a gripping member that is provided so as to surround the drain wire 2 and that comes into contact with or comes apart from the drain wire 2 by the drive by the drive device.

After completion of the squeeze control by the squeeze device 10X, the multi-core cable 1 is carried to the twist device 10Y. As shown in FIG. 10, the twist device 10Y includes a second gripping clamp 40Y, a second drive device 50Y, a second moving device 60Y and a rotating device 70. The configuration of the twist device 10Y may be similar to that of the drain wire correcting device 10 first described. The second drive device 50Y drives clamp jaws 41Y and 42Y of the second gripping clamp 40Y so as to grip or release the drain wire 2. The second drive device 50Y is configured to at least cause the second gripping clamp 40Y to strongly grip the drain wire 2. The gripping force of the second gripping clamp 40Y generated by the second drive device 50Y does not need to be changeable from the gripping force of the strong grip. The second moving device 60Y is configured to move the second gripping clamp 40Y along the axis Ax2. The axis Ax2 is the rotating axis of the second gripping clamp 40Y, and the direction of extension coincides with the axial direction of the squeezed drain wire 2 attached to the twist device 10Y. The rotating device 70 rotates the second gripping clamp 40Y around the axis Ax2. The operation of the rotation control by the twist device 10Y may be the same as in the first embodiment. The twist device 10Y may be set to perform the release control or not to perform the release control. When the release control is not performed, the twist device 10Y may not include the second moving device 60Y.

The drain wire correcting device 10 uses a plurality of clamps for gripping the drain wire 2 with different gripping forces, instead of using a clamp capable of switching the gripping force for gripping the drain wire 2. Such a drain wire correcting device 10 also allows for desirable correction of the drain wire 2 by preventing the strands of the drain wire 2 from being cut or from being twisted insufficiently for the same reasons as in the first embodiment.

The retention device for retaining the drain wire may include a multi-jointed robot arm, for example. When a multi-jointed robot arm is used as a retention device of a drain wire correcting device, which is divided between a squeeze device and a twist device as described above, the robot arm may, for example, carry a multi-core cable from another device to the squeeze device, carry the multi-core cable from the squeeze device to the twist device, carry the multi-core cable from the twist device to another device. When a multi-jointed robot arm is used as a retention device of a drain wire correcting device as in the first embodiment, the robot arm may, for example, carry a multi-core cable from another device to the drain wire correcting device, carry the multi-core cable from the drain wire correcting device to another device, etc. In the case of any of the applications to the drain wire correcting device described above, the relative movement of the gripping clamp and the multi-core cable in the squeeze control, the rotation of the multi-core cable in the rotation control, the relative movement of the gripping clamp and the multi-core cable and the rotation of the multi-core cable in the release control may be performed by the movement of the robot arm.

The correcting of the drain wire may be performed without using the drain wire correcting device. For example, the correcting of the drain wire may be performed using a gripper capable of gripping the drain wire and capable of changing the gripping force. In this case, the operator may hold the gripper in his hand to perform the correcting operation of the drain wire. The portion of the gripper that grips the drain wire may be rotatable. There are no particular limitations on devices, tools, instruments, etc., for implementing the method for correcting the drain wire disclosed herein.

### DESCRIPTION OF REFERENCE SIGNS

1 Multi-core cable
2 Drain wire
2a Root portion
2b Distal end portion
3 Core wire
4 Sheath
10 Drain wire correcting device
20 Retention device
30 Gripping device
40 Gripping clamp
41 First clamp jaw (first clamp)
41b First gripping portion
42 Second clamp jaw (second clamp)
42b Second gripping portion
50 Drive device
60 Moving device
70 Rotating device
80 Controller

1: A drain wire correcting device, comprising:
a retention device configured to retain a sheathed portion of a multi-core cable, the multi-core cable including the sheathed portion covered with a sheath and a drain wire exposed from the sheathed portion;
a gripping member configured to be capable of gripping the drain wire on a predetermined axis;
a drive device configured to drive the gripping member so as to grip or release the drain wire;
a moving device configured to move at least one of the multi-core cable retained by the retention device and the gripping member along the axis;
a rotating device configured to rotate at least one of the multi-core cable retained by the retention device and the gripping member around the axis; and
a controller configured to control the drive device, the moving device and the rotating device,
wherein the controller is configured to execute:
a squeeze control of moving the gripping member along the axis relative to the multi-core cable while the gripping member is in contact with the drain wire, thereby squeezing the drain wire toward a distal end side; and
a rotation control, after the squeeze control, of causing the gripping member to grip the drain wire with a gripping force increased from that in the squeeze control, and rotating the gripping member around the axis relative to the sheathed portion.

2: The drain wire correcting device according to claim 1, wherein the controller is configured to, in the squeeze control, cause the gripping member to grip the drain wire with a gripping force weaker than that in the rotation control.

3: The drain wire correcting device according to claim 1, wherein the controller is configured to, in the rotation control, drive the moving device so that the gripping member pulls the drain wire toward the distal end side of the drain wire.

4: The drain wire correcting device according to claim 1, wherein the controller is configured to, after the rotation control, execute a release control of causing the gripping member to grip the drain wire with a gripping force weaker than that in the rotation control, rotating the gripping member around the axis relative to the sheathed portion, and moving the gripping member along the axis toward the distal end side of the drain wire, thereby releasing the gripping member from the drain wire.

5: The drain wire correcting device according to claim 4, wherein a moving speed of the gripping member relative to the drain wire in the squeeze control is faster than a moving speed of the gripping member relative to the drain wire in the release control.

6: The drain wire correcting device according to claim 1, wherein the controller executes the rotation control while the gripping member is positioned at the distal end portion of the drain wire.

7: The drain wire correcting device according to claim 1, wherein the controller starts the squeeze control while the gripping member is positioned at a root portion of the drain wire.

8: The drain wire correcting device according to claim 1, wherein in the squeeze control, the controller rotates the gripping member around the axis relative to the sheathed portion while moving the gripping member toward the distal end side of the drain wire while the gripping member is in contact with the drain wire.

9: The drain wire correcting device according to claim 1, wherein:
the gripping member includes:
a first clamp including a first gripping portion that is notched in a shape corresponding to a cross-sectional shape of the drain wire; and
a second clamp including a second gripping portion that is notched in a shape corresponding to the cross-sectional shape of the drain wire and is arranged so as to face the first gripping portion; and
the drive device is configured to move the first clamp and the second clamp toward or away from each other.

10: A drain wire correcting device comprising:
a retention device configured to retain a sheathed portion of a multi-core cable, the multi-core cable including the sheathed portion covered with a sheath and a drain wire exposed from the sheathed portion;
a squeezing member configured to be in contact with the drain wire so as to surround the drain wire;
a gripping member configured to be capable of gripping the drain wire;
a drive device configured to drive the gripping member so as to grip or release the drain wire;
a moving device configured to move at least one of the multi-core cable retained by the retention device and the squeezing member so that the squeezing member and the sheathed portion move away from each other;
a rotating device configured to rotate at least one of the multi-core cable retained by the retention device and the gripping member around a predetermined axis; and
a controller configured to control the drive device, the moving device and the rotating device,
wherein the controller is configured to execute:
a squeeze control of moving the squeezing member relative to the multi-core cable while the squeezing member is in contact with the drain wire, thereby squeezing the drain wire toward a distal end side; and
a rotation control, after the squeeze control, of causing the gripping member to grip the drain wire, and rotating the gripping member around the axis relative to the sheathed portion.

11: The drain wire correcting device according to claim 10, wherein:
the squeezing member is configured to be capable of gripping the drain wire;
the drain wire correcting device further comprises another drive device configured to drive the squeezing member so as to grip or release the drain wire based on a control of the controller; and
in the squeeze control, the controller controls the other drive device so as to cause the squeezing member to grasp the drain wire with a gripping force weaker than the gripping force by which the gripping member grips the drain wire in the rotation control.

12: The drain wire correcting device according to claim 10, further comprising:
another moving device configured to move at least one of the multi-core cable retained by the retention device and the gripping member along the axis,
wherein the controller is configured to, after the rotation control, execute a release control of causing the gripping member to grip the drain wire with a gripping force weaker than that in the rotation control, rotating the gripping member around the axis relative to the sheathed portion, and driving the other moving device to move the gripping member along the axis toward the distal end side of the drain wire, thereby releasing the gripping member from the drain wire.

13: A method for correcting a drain wire, comprising:
a first step of retaining a sheathed portion of a multi-core cable, the multi-core cable including the sheathed portion covered with a sheath and a drain wire exposed from the sheathed portion;
a second step of causing a gripper, capable of gripping the drain wire, to come into contact with an outer circumference of the drain wire;
a third step, after the second step, of moving at least one of the retained multi-core cable and the gripper while the gripper is in contact with the outer circumference of the drain wire, thereby moving the gripper toward a distal end side of the drain wire;
a fourth step, after the third step, of causing the gripper to grip the drain wire with a gripping force of the gripper increased from that in the third step; and
a fifth step, after the fourth step, of rotating at least one of the retained multi-core cable and the gripper around an axis of the drain wire while the drain wire is gripped by the gripper, thereby rotating the gripper around the axis of the drain wire relative to the sheathed portion.

14: The method for correcting a drain wire according to claim 13, wherein in the second step, the drain wire is gripped by the gripper with a gripping force weaker than that in the fourth step and the fifth step.

15: The method for correcting a drain wire according to claim 13, further comprising:
a sixth step, after the fifth step, of gripping the drain wire by the gripper with a gripping force weaker than the gripping force in the fourth step and the fifth step; and
a seventh step, after the sixth step, of rotating at least one of the retained multi-core cable and the gripper while the drain wire is gripped by the gripper around the axis of the drain wire, thereby rotating the gripper around the axis of the drain wire relative to the sheathed portion, and moving at least one of the retained multi-core cable and the gripper in an axial direction of the drain wire to move the gripper toward the distal end side of the drain wire, thereby releasing the gripper from the drain wire.
